(19) United States
(12) Patent Application Publication
(10) Pub. No.: US 2022/0413310 A1
(43) Pub. Date: Dec. 29, 2022

(54) Method and Technique for the Focusing of UVC Light Energy to a Focused Energy Beam

(71) Applicants: Ronald Scott Frazier, Dededo, GU (US); Nicholas A. Connelly, Ballston Spa, NY (US); William E. Ray, JR., Dededo, GU (US)

(72) Inventors: Ronald Scott Frazier, Dededo, GU (US); Nicholas A. Connelly, Ballston Spa, NY (US); William E. Ray, JR., Dededo, GU (US)

(21) Appl. No.: 17/362,663

(22) Filed: Jun. 29, 2021

(51) Int. Cl. G02B 27/09; G02B 27/42

(52) U.S. Cl. CPC G02B 27/0944; G02B 27/4233

(57) ABSTRACT

An array that focuses UVC light energy from a UVC light source into a beam and thereby reduces the degradation of UVC light energy at a set distance. Singular or plural optics, or lens assemblies forming the array can each use a Diffractive Optical Element (“DOE”) with a beam width of UVC energy with acceptable transmission through the DOE, which transmits a UVC beam through a relay lens which thereby allows an extended distance greater that the fall off rate of the standard UVC energy source. Lens assemblies can include a series of spacers and lenses that allow the manipulation of a wide angle UVC light source for the purpose of focusing the light to a desired beam shape, i.e., a thin line or bar, or a pin point. Each of the optics may have one or more spacers set at a specific width to add to the total beam shaping of the lenses.

### BACKGROUND

It has been noted that UVC light energy produced by UVC diodes and UVC tube/lamps are radiated in a wide angle (degrees). UVC diodes typically have 120 degrees to 150 degrees radiation pattern, UVC tubes can radiate up to a 360-degree radiation pattern and UVC Lamps can radiate in a conical pattern at up to 150 degrees.

It is also noted that the light energy degradation is expressed by an inverse-square law. This degradation is known as fall-off.

It is common practice to use reflectors or other light mirrors to direct the rays of light to the desired target area. These methods are inefficient and rely on the reflecting of light rays off a reflective material to achieve a desired light direction.

U.S. Pat. Nos. 8,021,608 and 8,318,089; and US Published Patent Application 2018/0343847 disclose UVC sterilizing devices and are herein incorporated by reference.

The present inventors have recognized that it would be desirable to direct UVC radiation to a desired position with minimal degradation of UVC light energy.

### SUMMARY

The exemplary embodiments of the invention focus UVC light energy from a UVC light source into a beam and thereby reduces the degradation of UVC light energy at a set distance.

Singular or plural optics or lens assemblies can each use a Diffractive Optical Element (“DOE”) with a beam width of UVC energy with acceptable transmission through the DOE, which transmits a UVC beam through a relay lens which thereby allows an extended distance greater that the fall off rate of the standard UVC energy source. A lens assembly can include a series of spacers and lenses that allow the manipulation of a wide angle UVC light source for the purpose of focusing the light to a desired beam shape, i.e., a thin line or bar, or a pin point. Each of the optics or lens assemblies may have one or more spacers having a specific width to add to the total beam shaping of the lenses.

The invention includes a UVC apparatus for focusing a UVC light source into a beam having increased energy at a set distance.

The apparatus can comprise a Diffractive Optical Element (“DOE”) transmitting a beam width of UVC energy which is then transmitted through a relay lens which thereby allows an extended distance greater that the fall off rate of the standard UVC energy source.

The UVC apparatus can include a spacer set at a specific width to add to the total lens effect.

Numerous other advantages and features of the present invention will be become readily apparent from the following detailed description of the invention and the embodiments thereof, and from the accompanying drawings.

### BRIEF DESCRIPTION OF THE DRAWING

In the following detailed portion of the present description, the teachings of the present application will be explained in more detail with reference to the example embodiment shown in the drawings, in which:

FIG. 1 is a schematic exploded side view of an exemplary embodiment UVC lens assembly.

FIG. 2 is a schematic exploded side view of the UVC lens assembly of FIG. 1 mounted to a UVC LED diode according to an exemplary embodiment.

FIG. 3 is a schematic side view of the UVC lens assembly mounted to a UVC LED diode as shown in FIG. 2 in a lens assembly configuration of a four-assembly array according to another exemplary embodiment, with a top lens assembly shown in exploded fashion and the remaining three lens assemblies shown assembled.

FIG. 4 is a schematic side view of the UVC lens assembly mounted to a UVC LED diode as shown in FIG. 2 in a lens assembly configuration of a five-assembly array to produce a beam multiplier according to another exemplary embodiment.

FIG. 5 is a schematic plan view of the UVC lens assembly mounted to a UVC LED diode as shown in FIG. 2 in a honeycomb configuration to produce a beam multiplier according to another exemplary embodiment.

FIG. 6 is a schematic plan view of the UVC lens assembly mounted to a UVC LED diode as shown in FIG. 2 arranged in a straight-line configuration to produce an energy beam at a specified width and distance according to another exemplary embodiment.

FIG. 7 is a schematic side view of the UVC lens assembly mounted to a UVC LED diode as shown in FIG. 2 arranged in a straight-line configuration to produce an energy beam at a specified width and at a specified distance according to another exemplary embodiment.

FIG. 8 is a schematic end view of a four-sided device incorporating the UVC lens assembly mounted to a UVC LED diode as shown in FIG. 2 according to another exemplary embodiment.

FIG. 8A is a schematic enlarged end view taken from FIG. 8.

FIG. 9 is a schematic sectional view taken generally through plane 9-9 in FIG. 8.

FIG. 10 is a schematic side view of the UVC lens assembly mounted to a UVC LED diode as shown in FIG. 2 to produce a beam multiplier according to another exemplary embodiment.

FIG. 11 is a schematic exploded side view of the UVC lens assembly mounted to a UVC LED diode as shown in FIG. 2 in an array to change the output energy of a UVC tube light according to another exemplary embodiment.

FIG. 12 is a schematic side view of another embodiment UVC lens assembly mounted adjacent to a UVC LED diode array.

FIG. 13 is a top perspective view of another embodiment UVC lens assembly mounted adjacent to a UVC LED diode array.

FIG. 14 is a top perspective view of another embodiment UVC lens assembly mounted adjacent to a UVC LED diode array.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

In the following detailed description, the DOE and relay lens are produced from a doped SiO₂ wafer growth or glass mold using a wafer comprised of SiO₂ and other impurities/dopants. Utilizing a designed mask for the lens shape, the wafer is cut or etched, and the lens produced. A second process uses a fabricated mold to accomplish the making of the lens out of the doped SiO₂ material. The second method is also accomplished by using UV transmitting filters which contain compositions using other glass and/or silicon type of material.

It is noted that polymers that can pass UVC energy can be used instead of, or in combination with, SiO₂ materials in the production of the invention.

Doped SiO₂ material is designed to pass UVC at frequencies in the UVC range with none or some energy loss at <70% percentage.

This design has several optical elements, spacers and a mounting fixture. The first element is for the focusing and shaping of light from a given UVC emitter with narrow light output of any desired shape. This element is called the “DOE.”

A second optical element is called the “relay lens.” The relay lens projects the energy at a controlled shape, either line or point at a specified distance.

The spacers, when used, between the UVC emitter, DOE and the Relay lens are used together to align and position the element to optimize the light energy.

This combination of spacers and optical elements allows for greater output energy at a given distance.

Finally, the groups of components are fastened, utilizing a framed mount, to the Printed Circuit Board (PCB) which a UVC SMD (surface mounted device) is mounted.

A second application is to the UVC tube, whereas UVC Beam energy lenses can be applied in an array to accomplish a focalized beam pattern at a specified distance.

It is noted that the application of this invention can be applied to UVC tube lights and UVC bulbs.

It is also noted that the invention can be applied to present UVC laser technology.

Light degrades over distance which follows the inverse square law 1/R². R=distance from UVC source to target location. This light falls off exponentially and creates problems when trying to design a device using UVC technology. According to embodiments of the invention, a higher output can be achieved at a given distance greater than the original source could previously obtain.

For example: for a 100 mW UVC LED, the total light output from the LED will be spread across a 120-150-degree angle. The light is dispersed very broadly and ultimately diluting its effectiveness at greater distances. For using UVC light at greater distances, it may be necessary to add more light sources (UVC LEDs or Lamps) to accommodate the loss in power due to the inverse square law.

But now, with this invention, light energy can be consolidated and project more photons in a desired beam size and shape.

This focusing increases the total power at the distance that is targeted, allowing more of the UVC light to reach the target, without having to add more light sources.

An approximate four order of magnitude increase in power output is calculated at a target location at a given distance from source, compared to having a standard light source reaching that same target location.

The focusing technology can be applied in different beam paths and shapes. This allows for unique applications and provides an easy solution for hard-to-reach areas. The shaping of the beam is advantageous based on user application, with the flexibility of changing beam widths and shapes, the technology can be used for all UVC light sources between 200 nm-280 nm wavelengths.

The exemplary embodiments described herein could drastically increase cost savings, decrease power consumption, and decrease UVC irradiation time, all with using less of the UVC source being applied. The exemplary embodiments provide enhanced safety, in that by focusing UVC radiation, UVC radiation in areas that are not of interest is reduced.

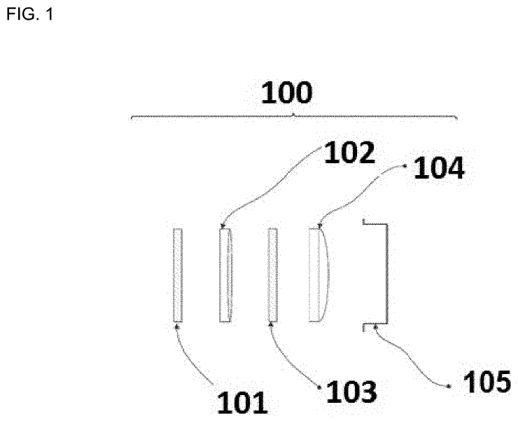

FIG. 1 depicts an exemplary embodiment of UVC lens assembly 100. The lens assembly 100 may includes a spacer 101; a DOE lens 102; a second spacer 103, and a relay lens 104, in order. Spacers 101 and 103 may or may not be required for assembly. The relay lens 104 includes a mount 105 for the lens assembly 100 to attach to a UVC LED board. The spacers 101, 103 can be hollow cylinders allowing UVC light to pass through the spacers.

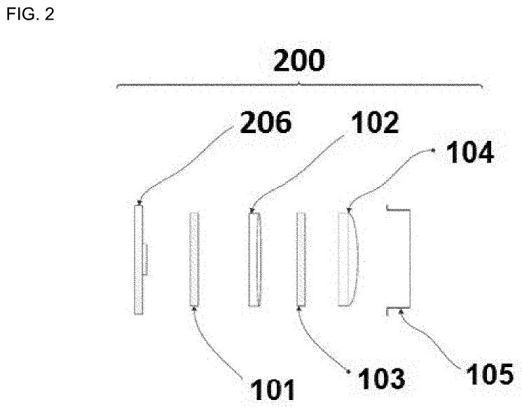

FIG. 2 depicts an exemplary embodiment of UVC emitter-lens assembly 200. The assembly 200 includes the assembly 100 from FIG. 1 mounted to a UVC emitter assembly 206. The assembly 206 includes a UVC LED circuit board containing a UVC element/UVC LED.

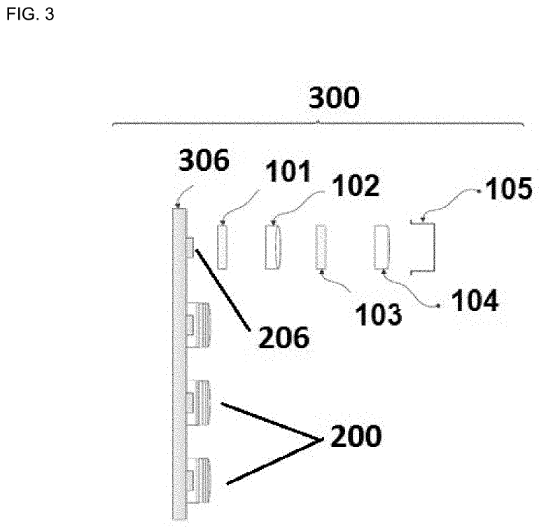

FIG. 3 depicts an emitter-lens array 300 having a plurality (such as four) of UVC emitter-lens assemblies 200. The emitter-lens assemblies 200 are mounted onto a UVC LED circuit board assembly 306.

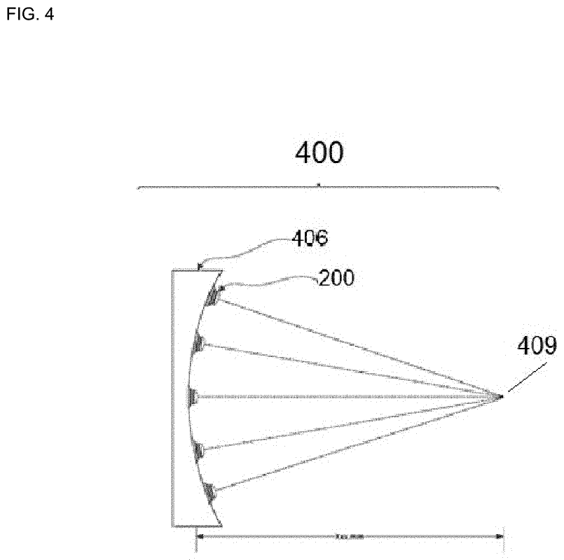

FIG. 4 depicts an emitter-lens array 400 having a plurality (such as five) of UVC emitter-lens assemblies 200. The emitter-lens assemblies are mounted onto a shaped circuit board or heat sink 406, which can be shaped in an arc or in a parabolic shape, directing the emitter-lens assemblies 200 to increase UVC energy at a specific focal point 409.

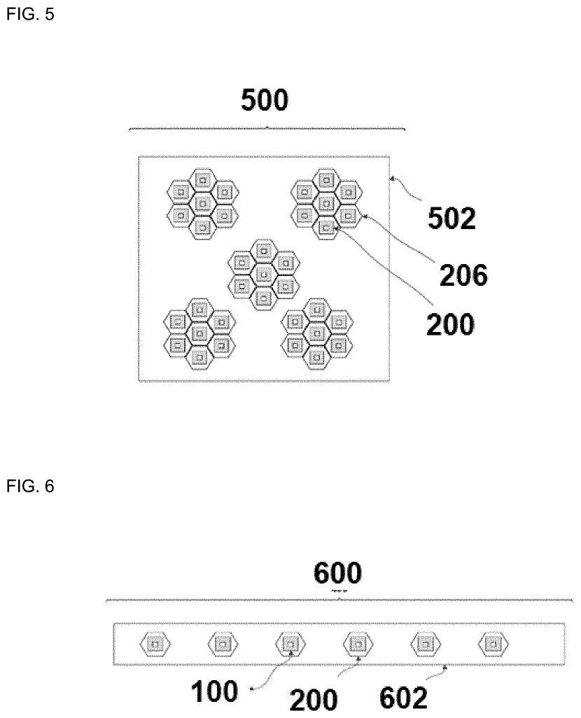

FIG. 5 depicts an emitter-lens array 500 having a plurality of UVC emitter-lens assemblies 200 in a honeycomb shaped pattern on a circuit board or heat sink 502. Each UVC emitter-lens assemblies 200 has a hexagon shape. The circuit board 502 carries UVC emitter-lens assemblies 200 to increase UVC energy at a specific beam width pattern or specific beam focal point.

FIG. 6 depicts an emitter-lens array 600 having a plurality (such as six) of UVC emitter-lens assemblies 200 arranged in a linear pattern on a circuit board or heat sink 602. Each UVC emitter-lens assemblies 200 has a hexagon shape. The UVC emitter-lens assemblies 200 increase UVC energy at a specific beam width.

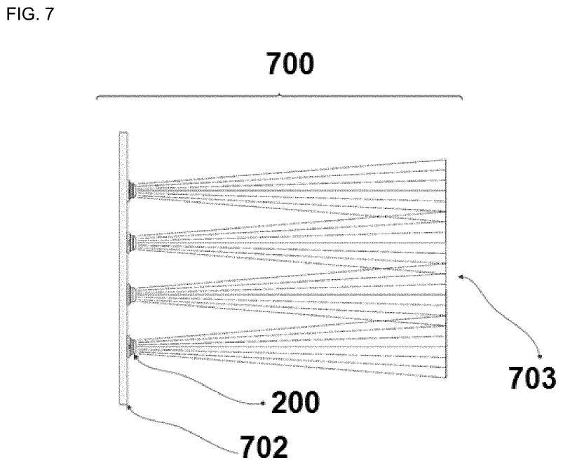

FIG. 7 depicts an emitter-lens array 700 having a plurality (such as four) of UVC emitter-lens assemblies 200 arranged in a linear pattern on a circuit board or heat sink 702. The UVC emitter-lens assemblies 200 increase UVC energy beam at a specific focus width and distance to a focus beam point 703.

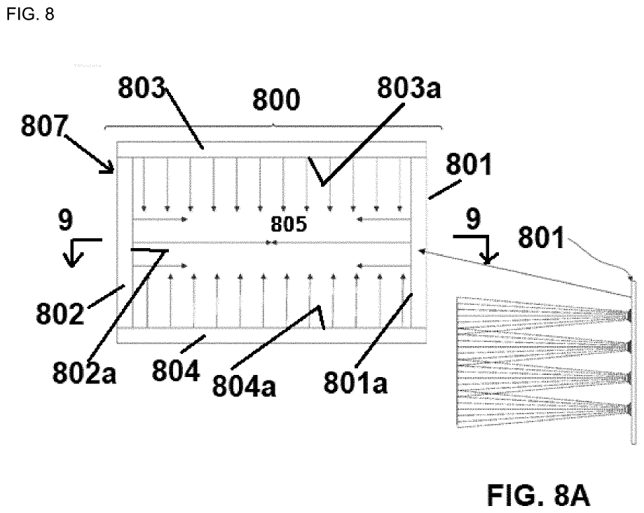

FIGS. 8 and 8A depict an exemplary embodiment of an emitter-lens array 800 having a plurality of UVC emitter-lens assemblies 200. The emitter-lens array 800 is incorporated onto UVC LED mounted circuit boards or heat sinks 801, 802, 803, 804 each carrying plural UVC emitter-lens assemblies 200 in an array 801a, 802a, 803a, 804a, and arranged in a rectangle and extending into the page and forming a four-sided UVC sterilization device 807 with an interior volume 805. Each array 801a, 802a, 803a, 804a incorporates UVC emitter-lens assemblies 200 directing UVC rays into the volume 805 to increase UVC energy at a specific focus width and distance. In FIG. 8, arrows are shown representing the direction of UVC light rays emitted from each UVC emitter-lens assembly 200. Each board or heat sink 801, 802, 803, 804 can be the assembly 700 depicted in FIG. 7.

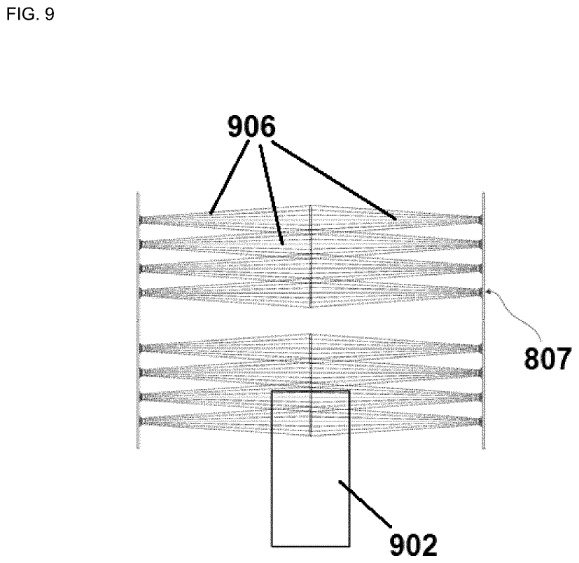

FIG. 9 Is a sectional view of the device 807 with an object 902 passing through the UVC energy beams 906. The UVC emitter-lens assemblies' 200 increases UVC energy at a specific focus width and distance to allow the UVC energy to fully cover the object at a distance greater that regular UVC LED components can presently accomplish.

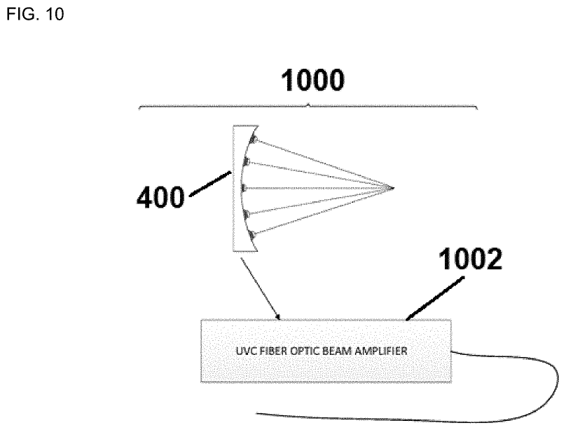

FIG. 10 depict an exemplary embodiment of an assembly 1000 including the emitter-lens array 400 from FIG. 4 having a plurality of UVC emitter-lens assemblies 200 incorporated into a UVC Fiber Optics Amplifier device 1002. The assembly 400 is enclosed within the UVC Fiber Optics Amplifier device 1002. UVC energy is focused to a single point leaving the UVC Fiber Optics Amplifier device which enables UVC fiber optic application. By utilizing the focus beam energy assembly, we can thereby increase the necessary UVC energy output into a fiber optic cable.

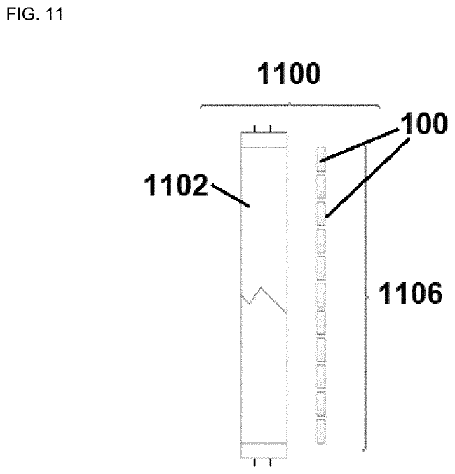

FIG. 11 depict an exemplary embodiment of an assembly 1100 including a UVC Tube type device 1102 and a plurality of UVC lens assemblies 100 arranged in a linear array 1106. The array 1106 increases UVC energy at a specific focal point. The array 1106 is mounted on the outside housing of the UVC Tube device with an insulating spacer, such as an air gap, or spacing material.

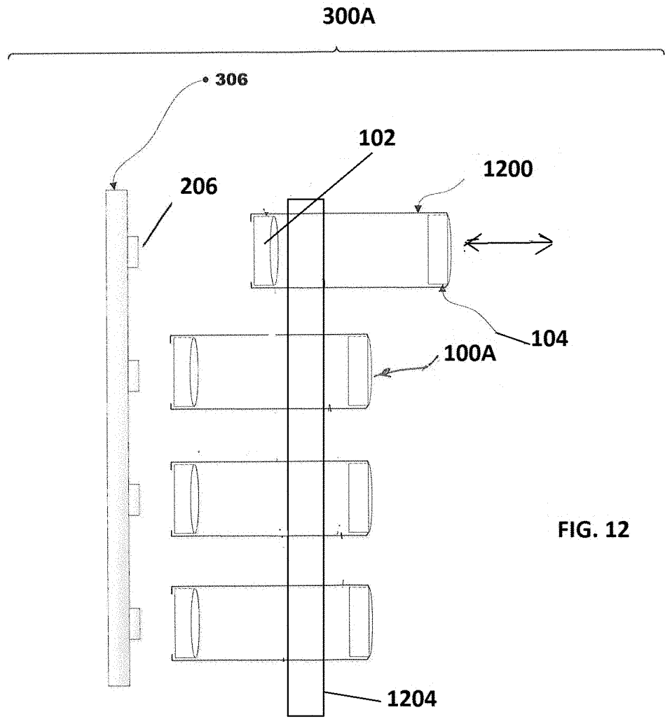

FIG. 12 illustrates an alternate embodiment, similar in some respects to FIGS. 1-3. An emitter-lens array 300A has a plurality (such as four) of UVC lens assemblies 100A. The lens assemblies 100A are in an assembly and are not physically attached to the UVC LED emitter circuit board assemblies 206 mounted on the circuit board or heat sink 306. The lens assemblies 100A are separated from the UVC LED emitter circuit board assemblies 206. The lens assemblies 100A can be held together in a frame 1204 that is molded or extruded and then placed in a position with the assemblies 100A spaced from the UVC LED emitter circuit board assemblies 206. The frame 1204 with lens assemblies 100A can be in the form of a lens cover or cap. The frame can be composed of plastic or metal. The lens assemblies can be attached to, or held by, the frame by friction, adhesive, molding with the frame, or other known method.

The assemblies 100A within a frame could be configured into a replacement cover to adapt to an existing product. The existing cover could be removed and replaced with a new cover that has the lens assemblies held in a frame.

Each assembly 100A includes a DOE lens 102 and a relay lens 104 mounted on opposite ends within a tubular housing 1200. The tubular housing 1200 is substantially hollow and acts as a spacer to set a desired distance between the two lenses 102, 104. The tubular housing can be a round cylinder, a square cross section tube, or the like.

The tubular housings 1200 can be molded with the frame 1204, adhesively secured to the frame 1204 or otherwise held by the frame 1204.

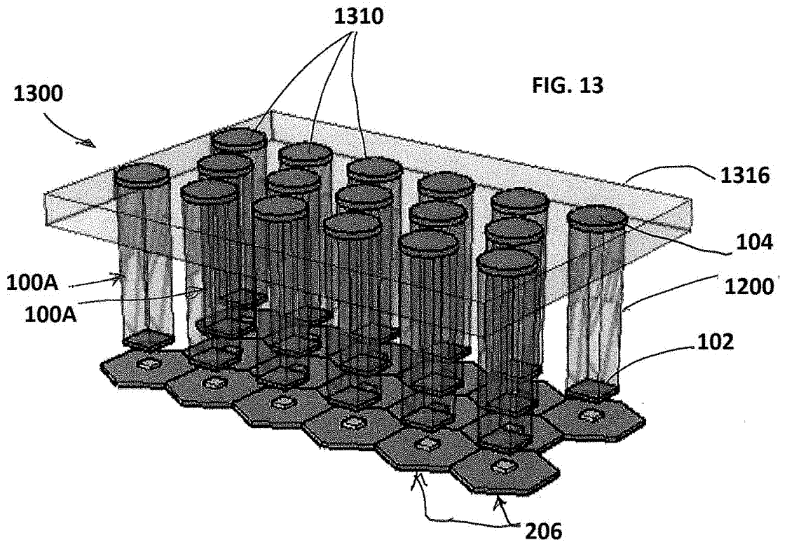

FIG. 13 depicts an alternate assembly 1300. The assembly 1300 includes a plurality of lens assemblies 100A fixed to a frame or cover 1316. Each lens assembly 100A includes a DOE lens 102 and a relay lens 104 mounted to or within a tube spacer 1200. The lens assemblies 100A, such as the quantity seventeen shown, are held together by the frame 1316 and can be placed over an array of UVC LED emitter circuit board assemblies 206 such as arranged in a honeycomb pattern (such as shown in FIG. 5). The tubular housings 1200 can be frictionally held in the frame 1316, molded with the frame 1316, adhesively secured to the frame 1316 or otherwise held by the frame 1316.

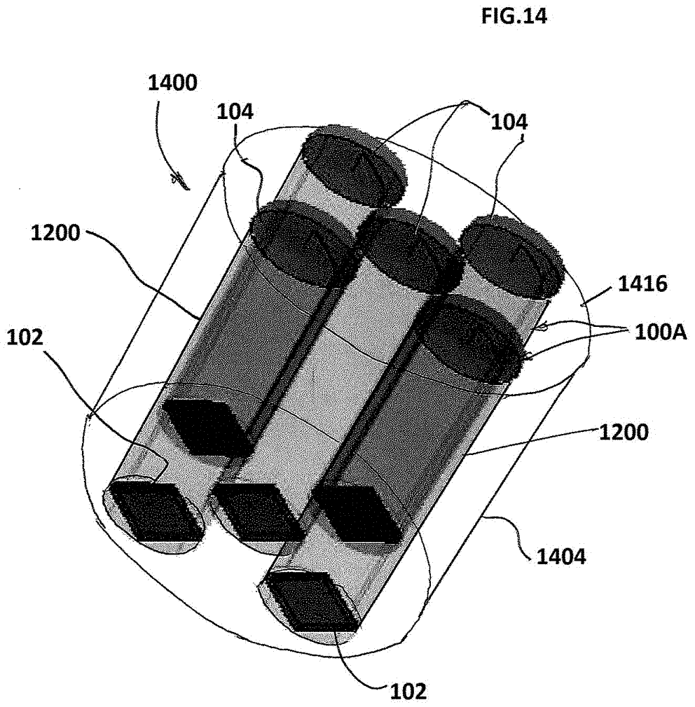

FIG. 14 depicts an alternate assembly 1400. The assembly 1400 includes a plurality of lens assemblies 100A fixed to a cylindrical frame or cover 1416. Each lens assembly 100A includes a DOE lens 102 and a relay lens 104 mounted to or within a tube spacer 1200. The lens assemblies 100A, such as the quantity seventeen shown, are held together by the frame 1416 and can be placed over an array of UVC LED emitter circuit board assemblies 206 (not shown) such as shown in FIG. 13. The tubular housings 1200 can be frictionally held in the frame 1416, molded with the frame 1416, adhesively secured to the frame 1416 or otherwise held by the frame 1416.

From the foregoing, it will be observed that numerous variations and modifications may be affected without departing from the spirit and scope of the invention. It is to be understood that no limitation with respect to the specific apparatus illustrated herein is intended or should be inferred.

The invention claimed is:

1. An array comprising plural UVC light sources which focus UVC light energy from a UVC light source into a UVC beam to fucus UVC light energy at a set distance.

2. The array according to claim 1, wherein each UVC light source comprises a Diffractive Optical Element with a beam width of UVC energy, which transmits a UVC beam through a Relay Lens which thereby allows an extended distance of UVC energy.

3. The array according to claim 2, wherein the Diffractive Optical Element comprises a series of spacers and lenses that allow the manipulation of a wide angle UVC light source for the purpose of focusing the light to a desired beam shape.

4. The array according to claim 1, wherein the plural UVC light sources are arranged along an arc.

5. The array according to claim 1, wherein the plural UVC light sources are arranged along a linear pattern.

6. The array according to claim 1, wherein the plural UVC light sources each have a polygonal perimeter and are arranged in a honeycomb pattern.

7. The array according to claim 1, wherein each UVC light source includes
a lens assembly including:
a first spacer;
a DOE lens;
a second spacer; and
a relay lens.

8. The array according to claim 7, wherein the relay lens includes a mount for the lens assembly to attach to a UVC LED board.

9. The array according to claim 1, arranged forming a four-sided UVC sterilization device with an interior volume.

10. The array according to claim 1, arranged forming a UVC sterilization chamber with an interior volume.

11. The array according to claim 1, wherein the array is enclosed within a UVC Fiber Optics Amplifier device, wherein UVC energy is focused to a single point leaving the UVC Fiber Optics Amplifier device.

12. An array comprising a UVC light source and a plurality of lens assemblies, each having a Diffractive Optical Element with a beam width of UVC energy, which transmits a UVC beam through a Relay Lens which thereby allows an extended distance of UVC energy. which focus UVC light energy from a UVC light source into a UVC beam to fucus UVC light energy at a set distance.
